(19) United States
(12) Patent Application Publication
(10) Pub. No.: US 2006/0143598 A1
(43) Pub. Date: Jun. 29, 2006

(54) Method and apparatus for transforming program representations

(76) Inventors: Vincent J. Zimmer, Federal Way, WA (US); Michael A. Rothman, Puyallup, WA (US); David C. Estrada, Beaverton, OR (US)

Correspondence Address: LAWRENCE CHO;C/O PORTFOLIOIP, P. O. BOX 52050, MINNEAPOLIS, MN, 55402, US

(21) Appl. No.: 11/024,529

(22) Filed: Dec. 29, 2004

(51) Int. Cl. G06F 9/45; G06F 9/44

(52) U.S. Cl. 717/136; 717/114

(57) ABSTRACT

A method for managing code includes translating source code in C to Advance Configuration Power Interface (ACPI) Source Language (ASL). Other embodiments are described and claimed.

### FIELD

Embodiments of the present invention relate to tools for developing code stored in basic input output systems (BIOS). More specifically, embodiments of the present invention relate to tools for developing Advanced Configuration and Power Interface (ACPI) (Revision 2.0c published Aug. 25, 2003) Source Language (ASL) applications.

### BACKGROUND

The ACPI specification defines hardware and software interfaces that enable operating system directed configuration and power management to enumerate and configure motherboard devices and manage their power. ACPI enables new power management technology to evolve independently in operating systems and hardware while ensuring they work together.

Platform firmware developers are required to provide framework drivers that control power capabilities of the platform and its interfaces in native machine code (e.g., IA32®, Itanium® Processor Family). The platform firmware developers are also required to describe the power capabilities of the platform to an operating system in ACPI Machine Language (AML) to be used by the operating system. Both the machine code and the AML code are stored in the system's flash BIOS. When the system is booted up, the machine code is used by the BIOS to communicate with system interfaces. The AML code is copied into RAM by the BIOS startup code where it is interpreted by the operating system's ACPI AML interpreter to allow the operating system to communicate with the system interfaces.

Although both the machine code and AML code stored in the BIOS provide similar information, the system designer is required to separately write C code for compilation to the machine code and ASL code for compilation to the AML code. Coding the information in C and ASL requires additional time and resources which is undesirable.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 is a block diagram of an exemplary computer system in which an example embodiment of the present invention may be implemented.

FIG. 2 is a block diagram that illustrates a code translator according to an example embodiment of the present invention.

FIG. 3a illustrates an example of code that is processed by the code translator according to an example embodiment of the present invention.

FIG. 3b illustrates an example of code that is generated by the code translator according to an example embodiment of the present invention.

FIG. 4 is a flow chart illustrating a method for managing code according to an example embodiment of the present invention.

FIG. 5 illustrates an alternative embodiment of a code translator according to an example embodiment of the present invention.

### DETAILED DESCRIPTION

In the following description, for purposes of explanation, specific nomenclature is set forth to provide a thorough understanding of embodiments of the present invention. However, it will be apparent to one skilled in the art that specific details in the description may not be required to practice the embodiments of the present invention. In other instances, well-known components, programs, and procedures are shown in block diagram form to avoid obscuring embodiments of the present invention unnecessarily.

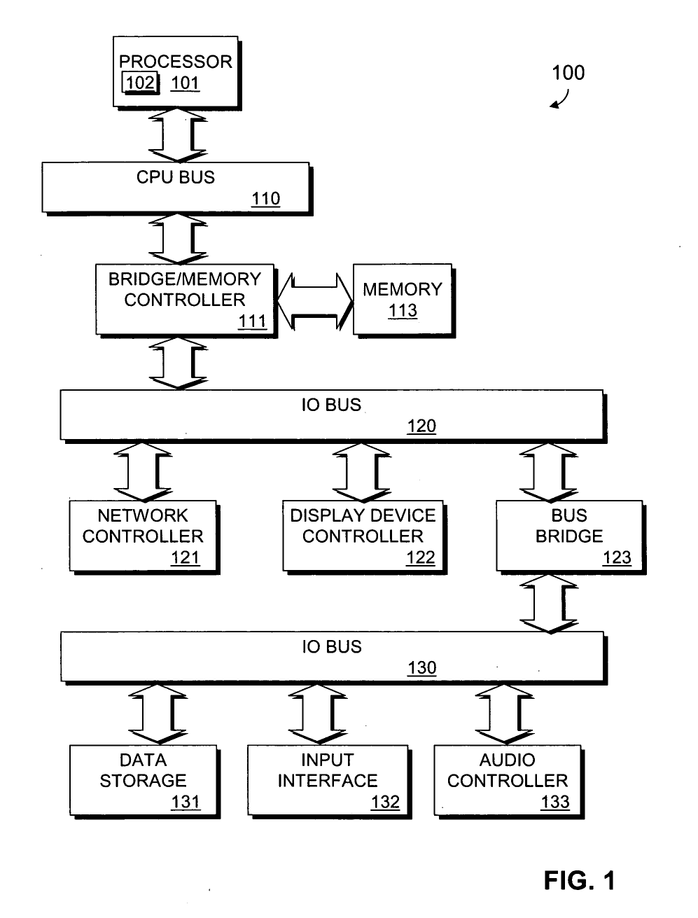

FIG. 1 is a block diagram of an exemplary computer system 100 according to an embodiment of the present invention. The computer system 100 includes a processor 101 that processes data signals and a memory 113. The processor 101 may be a complex instruction set computer microprocessor, a reduced instruction set computing microprocessor, a very long instruction word microprocessor, a processor implementing a combination of instruction sets, or other processor device. FIG. 1 shows the computer system 100 with a single processor. However, it is understood that the computer system 100 may operate with multiple processors. The processor 101 is coupled to a CPU bus 110 that transmits data signals between processor 101 and other components in the computer system 100.

The computer system 100 includes memory 113. The memory 113 may include a dynamic random access memory device, a static random access memory device, read-only memory, and/or other memory devices. The memory 113 may store instructions and code represented by data signals that may be executed by the processor 101.

According to an example embodiment of the present invention, the computer system 100 may implement a code translator stored in the memory 113. The translator may be executed by the processor 101 in the computer system 100 to translate code from a first source language to a second source language. In one embodiment, the code translator translates source code written in C to ASL. According to an alternate embodiment of the present invention, the code translator translates ASL to source code written in C.

A cache memory 102 resides inside processor 101 that stores data signals stored in memory 113. The cache 102 speeds access to memory by the processor 101 by taking advantage of its locality of access. In an alternate embodiment of the computer system 100, the cache 102 resides external to the processor 101. A bridge memory controller 111 is coupled to the CPU bus 110 and the memory 113. The bridge memory controller 111 directs data signals between the processor 101, the memory 113, and other components in the computer system 100 and bridges the data signals between the CPU bus 110, the memory 113, and a first IO bus 120.

The first IO bus 120 may be a single bus or a combination of multiple buses. The first IO bus 120 provides communication links between components in the computer system 100. A network controller 121 is coupled to the first IO bus 120. The network controller 121 may link the computer system 100 to a network of computers (not shown) and supports communication among the machines. A display device controller 122 is coupled to the first IO bus 120. The display device controller 122 allows coupling of a display device (not shown) to the computer system 100 and acts as an interface between the display device and the computer system 100.

A second IO bus 130 may be a single bus or a combination of multiple buses. The second IO bus 130 provides communication links between components in the computer system 100. A data storage device 131 is coupled to the second IO bus 130. The data storage device 131 may be a hard disk drive, a floppy disk drive, a CD-ROM device, a flash memory device or other mass storage device. An input interface 132 is coupled to the second IO bus 130. The input interface 132 may be, for example, a keyboard and/or mouse controller or other input interface. The input interface 132 may be a dedicated device or can reside in another device such as a bus controller or other controller. The input interface 132 allows coupling of an input device to the computer system 100 and transmits data signals from an input device to the computer system 100. An audio controller 133 is coupled to the second IO bus 130. The audio controller 133 operates to coordinate the recording and playing of sounds and is also coupled to the IO bus 130.

A bus bridge 123 couples the first 10 bus 120 to the second IO bus 130. The bus bridge 123 operates to buffer and bridge data signals between the first IO bus 120 and the second IO bus 130.

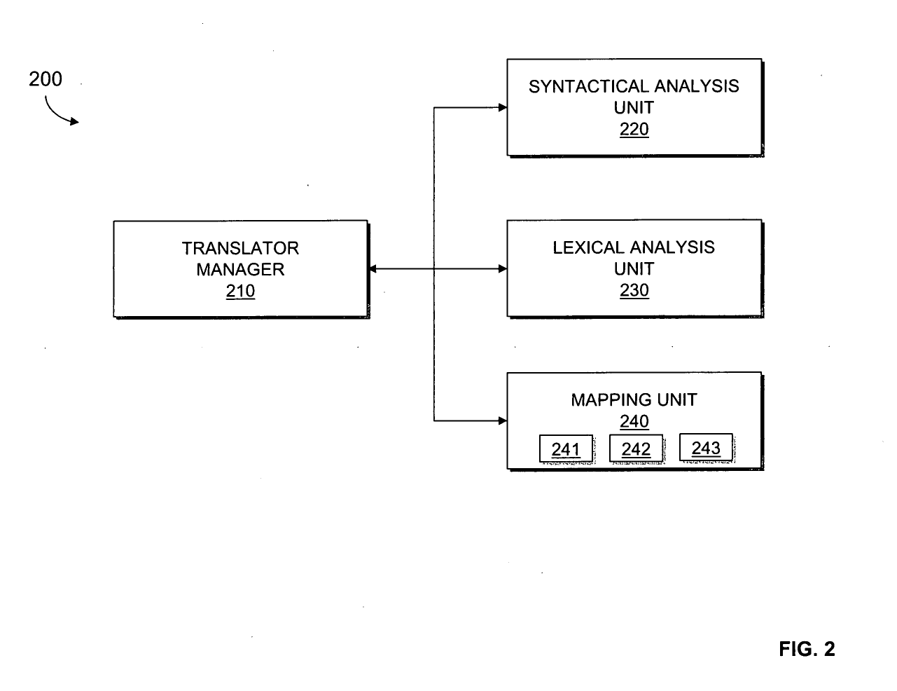

FIG. 2 is a block diagram that illustrates a code translator 200 according to an example embodiment of the present invention. The code translator 200 includes a plurality of modules, as shown, that may be implemented as hardware, software, or a combination of hardware and software. According to an embodiment of the present invention, the code translator 200 may be implemented on a computer system such as the one illustrated in FIG. 1. The code translator 200 operates to translate code written in a first source language to a second source language. According to an embodiment of the present invention, the first source language may be C and the second source language may be ASL. According to an alternate embodiment of the present invention, the first source language may be ASL and the second source language may be C. The code translator 200 includes a translator manager 210. The translator manager 210 receives code written in the first source language. The translator manager 210 interfaces with and transmits information between other components in the compiler 200.

The code translator 200 may include a syntactical analysis unit 220. The syntactical analysis unit 220 receives the code in the first source language, and performs syntactical analysis on the code. According to an embodiment of the translator 200, the syntactical analysis unit 220 identifies and corrects syntactical errors of the code in the first source language.

The code translator 200 may include a lexical analysis unit 230. The lexical analysis unit 230 receives the code in the first source language that may include code that has been analyzed by the syntactical analysis unit 220, and performs lexical analysis on the code. According to an embodiment of the translator 200, the lexical analysis unit 230 identifies tokens in the source code. Identifying tokens in the source code may include identifying lines or terms in the source code that are translatable into the second source language.

The code translator 200 may include a mapping unit 240. The mapping unit 240 receives the code in the first source language in the form of tokens identified by the lexical analysis unit 230, and translates the code in the first source language to the second source language. This may be achieved by mapping the tokens. According to an embodiment of the present invention where the code translator 200 translates code in C to ASL, the mapping unit 240 includes an input output unit 241. The input output unit 241 maps an input output operation in C to a store operation in ASL. The mapping unit 240 includes a time operation unit 242. The time operation unit 242 maps a stall operation in C to a sleep operation in ASL. The mapping unit 240 includes a function unit 243. The function unit 243 maps a function in C to a control method in ASL. According to an embodiment of the code translator 200, the mapping unit 240 may also map an I/O service, such as a Peripheral Component Interconnect (PCI) root bridge I/O to an ASL store operation.

It should be appreciated that the units described in the mapping unit 240 may map in one direction or another depending on the first and second source language. It should also be appreciated that other units may be included in the mapping unit 240 to further map other tokens identified. The translator 200 has been described in reference to translating source languages, such as American National Standard Institute (ANSI) C to ASL. It should be appreciated that the translator 200 may also map binary to AML directly. For example, the translator 200 may support off-line creation of ASL/AML from a 3^{rd} party binary driver or in-situ generation of AML in a system with a just-in-time (JIT) translation process. In this embodiment JIT logic may reside in the BIOS. This embodiment may be used when source code is not available with a driver.

It should be appreciated that the translator manager 210, syntactical analysis unit 220, lexical analysis unit 230, and mapping unit 240 may be implemented using any appropriate components, procedures, or techniques.

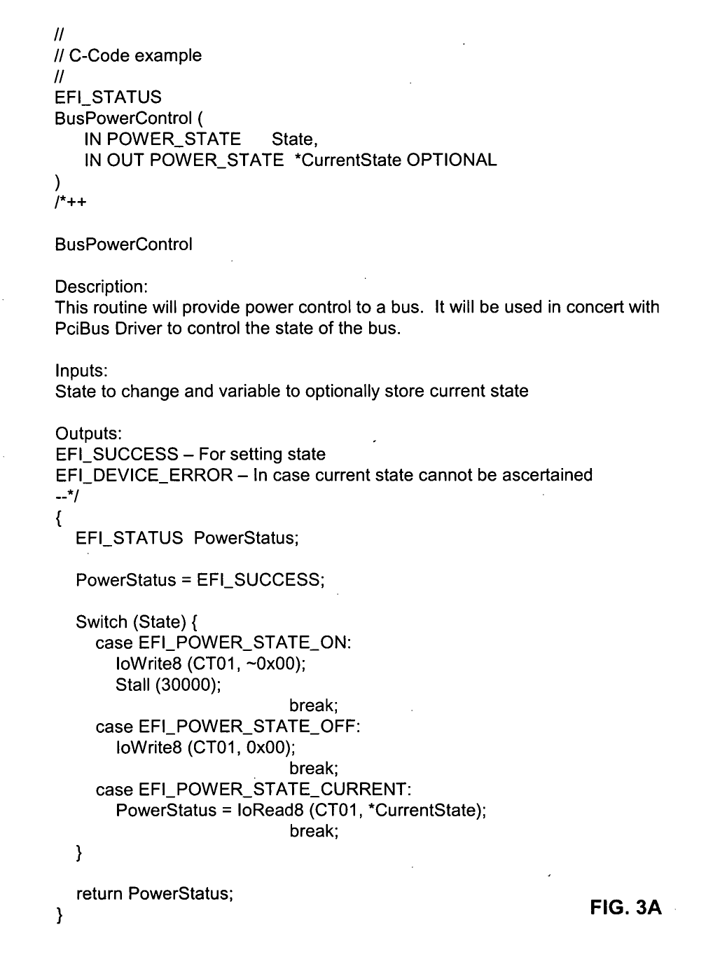

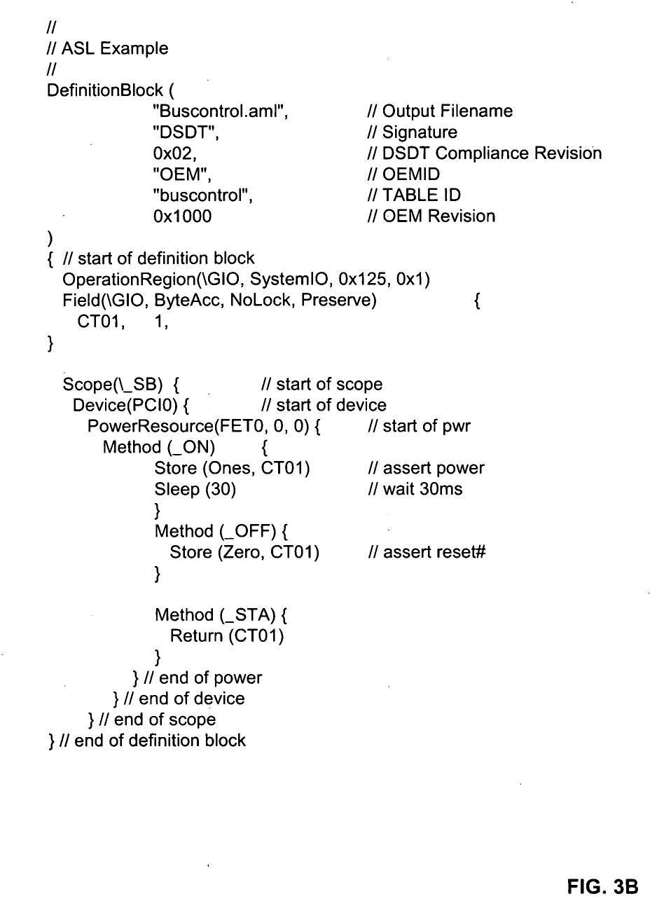

FIG. 3a illustrates an example of code that is processed by a code translator according to an example embodiment of the present invention. The code shown in FIG. 3a is a framework driver written in C. FIG. 3b illustrates an example of code that is generated by a code translator according to an example embodiment of the present invention. The code shown in FIG. 3b is ASL code translated from the framework driver written in C.

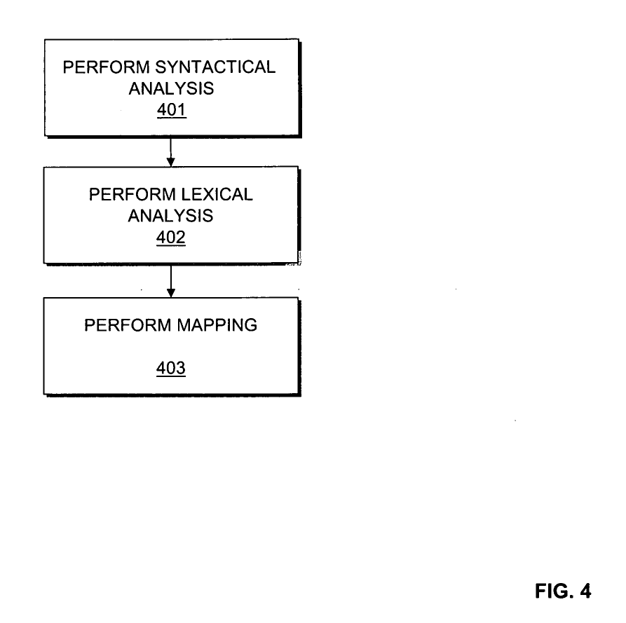

FIG. 4 is a flow chart illustrating a method for managing code according to an example embodiment of the present invention. According to an embodiment of the present invention, the method illustrated in FIG. 4 may be performed by the code translator 200 shown in FIG. 2. At 401, syntactical analysis is performed on code in a first source language. According to an embodiment of the present invention, syntactical analysis is performed by identifying and correcting errors in the code.

At 402, lexical analysis is performed on the code in the first source language. According to an embodiment of the present invention, lexical analysis is performed by identifying tokens in the source code. Identifying tokens may be achieved, for example, by identifying lines or terms in the source code that are translatable into the second source language.

At 403, mapping is performed on the code in the first source language. According to an embodiment of the present invention, mapping is performed by translating the code in the first source language to the second source language. This may be achieved, for example, by mapping the tokens. According to an embodiment of the present invention where the first source language is C and the second source language is ASL, mapping may include mapping an input output operation in C to a store operation in ASL. Mapping may include mapping a stall operation in C to a sleep operation in ASL. Mapping may also include mapping a function in C to a control method in ASL. It should be appreciated that other mapping procedures may be performed.

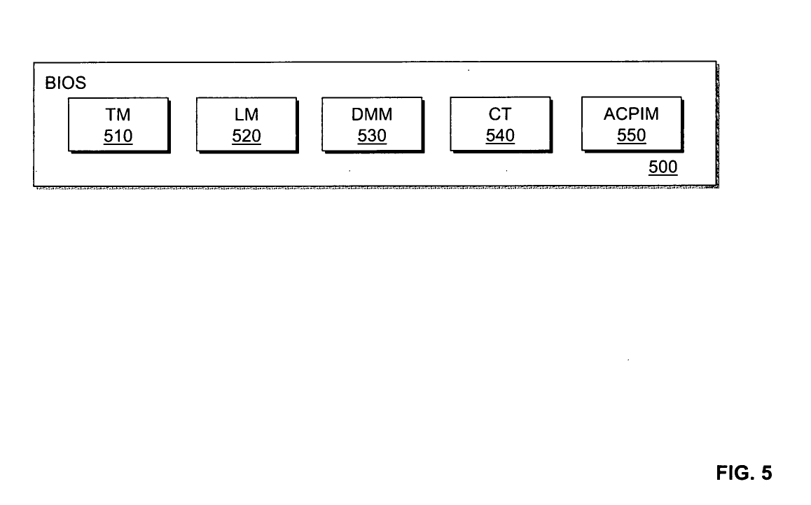

FIG. 5 illustrates an alternative embodiment of a code translator according to an example embodiment of the present invention. In this embodiment, the code translator may reside in a BIOS. FIG. 5 is a block diagram of a BIOS 500 used by a computer system according to an embodiment of the present invention. The BIOS 500 may be stored in the memory 113 (shown in FIG. 1). The BIOS 500 includes programs that may be run when a computer system is booted up and programs that may be run in response to triggering events. The BIOS 500 may include a tester module 510. The tester module (TM) 510 performs a power-on self test (POST) to determine whether the components on the computer system are operational.

The BIOS 500 may include a loader module (LM) 520. The loader module 520 locates and loads programs and files to be executed by a processor on the computer system. The programs and files may include, for example, boot programs, system files (e.g. initial system file, system configuration file, etc.), and the operating system.

The BIOS 500 may include a data management module (DMM) 530. The data management module 530 manages data flow between the operating system and components on the computer system 100. The data management module 530 may operate as an intermediary between the operating system and components on the computer system and operate to direct data to be transmitted directly between components on the computer system.

The BIOS 500 may include a code translator (CT) 540. The code translator 540 translates code in a first object language to code in a second object language. According to an embodiment of the BIOS 500, the code translator 540 translates object code from a framework driver written in X86 object code to AML. The code translator 540 may perform the translation directly on the object code of the framework driver or alternatively by observing the actions of the framework driver as it is run.

The BIOS 500 includes an ACPI module (ACPIM) 550. The ACPI module 550 operates to enable operating system-directed configuration and power management (OSPM). The ACPI module 500 describes the characteristic of a computer system by placing data, organized into tables, such as Root System Description Table (RSDT) and Differentiated System Description Table (DSDT) into a main memory of the computer system. According to an embodiment of the BIOS 500, the ACPI module 500 stores AML generated by the code translator 540.

It should be appreciated that the tester module 510, loader module 520, data management module 530, code translator 540, and ACPI module 550 may be implemented using any appropriate components, procedures, or techniques.

Embodiments of the present invention allow for code written in ASL to be generated from code written in C. Embodiments of the present invention utilize the fact that code written for framework drivers and in ASL access the same registers in a similar fashion and share the #defines that alias the registers. Thus, embodiments of the present invention allow for platform abstractions to be unified.

FIG. 4 is a flow chart illustrating methods for managing code according to an exemplary embodiment of the present invention. Some of the procedures illustrated may be performed sequentially, in parallel or in an order other than that which is described. It should be appreciated that not all of the procedures described are required, that additional procedures may be added, and that some of the illustrated procedures may be substituted with other procedures.

In the foregoing specification, the embodiments of the present invention have been described with reference to specific exemplary embodiments thereof. It will, however, be evident that various modifications and changes may be made thereto without departing from the broader spirit and scope of the embodiments of the present invention. The specification and drawings are, accordingly, to be regarded in an illustrative rather than restrictive sense.

What is claimed is:

1. A method for managing code, comprising:
translating source code in C to Advance Configuration Power Interface (ACPI) Source Language (ASL).

2. The method of claim 1, wherein translating the source code in C to ASL comprises mapping a token.

3. The method of claim 2, wherein mapping the token comprises mapping an input output operation to a store operation.

4. The method of claim 2, wherein mapping the token comprises mapping a stall operation to a sleep operation.

5. The method of claim 2, wherein mapping the token comprises mapping a function to a control method.

6. The method of claim 1, further comprising performing syntactical analysis on the source code.

7. The method of claim 6, wherein performing syntactical analysis comprises identifying and correcting syntactical errors in the source code.

8. The method of claim 1, further comprising performing lexical analysis on the source code.

9. The method of claim 8, wherein performing lexical analysis comprises identifying tokens in the source code.

10. An article of manufacture comprising a machine accessible medium including sequences of instructions, the sequences of instructions including instructions which, when executed, cause the machine to perform:
translating source code in C to Advance Configuration Power Interface (ACPI) Source Language (ASL).

11. The article of manufacture of claim 10, wherein translating the source code in C to ASL comprises mapping a token.

12. The article of manufacture of claim 11, wherein mapping the token comprises mapping an input output operation to a store operation.

13. The article of manufacture of claim 11, wherein mapping the token comprises mapping a stall operation to a sleep operation.

14. The article of manufacture of claim 11, wherein mapping the token comprises mapping a function to a control method.

15. A code translator, comprising:
a mapping unit to translate source code in C to Advance Configuration Power Interface (ACPI) Source Language (ASL).

16. The apparatus of claim 15, wherein the mapping unit comprises an input output unit to map an input output operation to a store operation.

17. The apparatus of claim 15, wherein the mapping unit comprises a time operation unit to map a stall operation to a sleep operation.

18. The apparatus of claim 15, wherein the mapping unit comprises a function unit to map a function to a control method.

19. The apparatus of claim 15, wherein the code translator resides in a basic input output system.

20. A computer system, comprising:
a memory; and
a processor implementing a code translator to translate source code in C to Advance Configuration Power Interface (ACPI) Source Language (ASL).

21. The apparatus of claim 20, wherein the code translator comprises a mapping unit to map an input output operation to a store operation.

22. The apparatus of claim 20, wherein the code translator comprises a mapping unit to map a stall operation to a sleep operation.

23. The apparatus of claim 20, wherein the code translator comprises a mapping unit to map a function to a control method.
